(19) United States
(12) Patent Application Publication
(10) Pub. No.: US 2002/0097248 A1
(43) Pub. Date: Jul. 25, 2002

(54) Three-dimensional CAD system

(76) Inventor: Shinya Kano, Osaka (JP)

Correspondence Address: VARNDELL & VARNDELL, PLLC, 106-A S. COLUMBUS ST., ALEXANDRIA, VA, 22314, US

(21) Appl. No.: 10/029,874

(22) Filed: Dec. 31, 2001

(30) Foreign Application Priority Data
Jan. 19, 2001 (JP) 012231/2001

(51) Int. Cl. G09G 5/00

(52) U.S. Cl. 345/622

(57) ABSTRACT

A non-reproducible three-dimensional model is shown on a first window and a third-dimensional model which has a part to be deleted or modified is shown on a second window. A difference between shape data and reference data of a part which is non-reproducible among the components of the immediately preceding three-dimensional model and shape data and reference data of the part in data about the non-reproducible three-dimensional model is determined, and data missing from the shape and reference data of the non-reproducible part 13 is extracted. The extracted data is shown as character information indicating the cause of non-reproducibility on a third window. Thus, the cause of non-reproducibility is shown on the screen, so that a person not skilled can complete the operation to re-create a three-dimensional model in a short time and efficiency of the operation can be improved.

### BACKGROUND OF THE INVENTION

1. Field of the Invention

The present invention relates to a three-dimensional CAD (Computer Aided Design) system.

2. Description of the Related Art

Manufacturers of construction machines use a three-dimensional CAD system to design such machines. One type of the three-dimensional CAD system has a parametric function.

The parametric function means a function of configuring a three-dimensional model by allotting an identification ID to respective components of the three-dimensional model and referencing to already stacked parts by other parts to stack them. For example, for three-dimensional model 30 of a gear case shown in FIG. 1, a part “projection” specified by shape number (identification ID) 13 is associated with a command (projection) for “forming a projected at a position distance d away from the center of a “boss” specified by shape number (identification ID) 12” or a parameter (identification ID 12, d). In other words, the part “projection” specified by the shape number (identification ID) 13 is associated with the part “boss” which is identified by the shape number (identification ID) 12 so to reference to it. Data (“forming a projection at a position the distance d away from the center of the “boss” identified by the shape number (identification ID) 12”) indicating a reference relation between parts is called reference data in this specification. Shape data indicating the shape of a part is allotted to each component. For example, the projection 13 is allotted coordinate position data about ridge lines and vertexes of its wire frame as shape data in order to create the shape of the projection 13 on a screen.

The three-dimensional model is reproduced on the screen by sequentially stacking parts to be stacked on the existing stacked parts according to the shape data and the reference data. The three-dimensional CAD system having the parametric function executes a command associated with the identification ID in order of the identification ID numbers to reproduce a shape of the three-dimensional model.

When a design is changed by Design Department of a manufacturer, data on a three-dimensional model whose design is to be changed is read and shown on the screen. The three-dimensional model is processed to delete or modify its part, and the three-dimensional model with its part deleted or modified is reproduced.

But, it happens that the reproduction of the three-dimensional model is disabled without completely reproducing its parts.

For example, even when a command for deleting the boss 12 from the parts configuring the three-dimensional model 30 is input as shown in FIG. 2, it can happen that the reproduction process is interrupted without completing the process and three-dimensional model 50 (non-reproducible three-dimensional model 50) whose reproduction is stopped without having its parts completely reproduced is shown on the screen as shown in FIG. 3. A model tree of the non-reproducible three-dimensional model 50 is shown in window screen 41 on screen 40 of FIG. 3. Here, the model tree shows respective commands (e.g., “projection”, “round”, etc.) for reproducing the three-dimensional model as a tree structure. The three-dimensional model is reproduced by sequentially executing the respective commands.

Accordingly, an operator is required to search the model tree of the non-reproducible three-dimensional model 50 for the cause of non-reproducibility and to re-create the three-dimensional model which can be reproducible.

But, the operation to search the model tree for the cause of the non-reproducibility requires a skill. Even if the operator is very conversant with software for the three-dimensional CAD, he or she cannot find the cause in a short time.

Therefore, a great deal of time is required to find the cause of the non-reproducibility and to re-create the three-dimensional mode, resulting in reducing work efficiency.

Then, there is described a technology of showing the shape of a part which is the cause of non-reproducibility on the screen in “Basic Knowledge of New CAD” (written and edited by Nikkei C G, Nikkei B P), pages 160 to 161.

According to this publication, a non-reproducible three-dimensional model and a three-dimensional model (immediately preceding three-dimensional model) immediately before the deletion of a part are shown on the same screen, so that the non-reproducible part is shown in a predetermined display color (green) distinguishable from the other parts on the immediately preceding three-dimensional model.

The operator can compare the part shown in the predetermined display color with the non-reproducible three-dimensional model to find the cause of the non-reproducibility.

Even if the shape of the part which is the cause of the non-reproducibility is shown, it is difficult to find why the part has become non-reproducible unless the operator is conversant with the three-dimensional CAD software.

The present invention has been completed under the aforementioned circumstances, and it is an object of the invention to enable a non-skilled person to complete re-creation of a three-dimensional model in a short time by showing the cause of non-reproducibility on the screen, thereby improving work efficiency.

As literatures indicating general technical levels, there are Japanese Patent Application Laid-Open Publications No. 9-282351 and No. 10-269259.

Japanese Patent Application Laid-Open Publication No. 9-282351 discloses an invention in which if there is a command error in the three-dimensional CAD, the cause of the command error is assumed from the past operation record.

And, Japanese Patent Application Laid-Open Publication No. 10-269259 discloses an invention in which image data created by a plurality of CAD software are overlaid to show differences so to catch a missing piece of information and a change in quality caused while the image data is passed among the plurality of CAD software.

### SUMMARY OF THE INVENTION

Accordingly, a first aspect of the invention is directed to a three-dimensional CAD system which comprises allotting shape data indicating the shape of a part to each component, allotting reference data indicating a reference relation to between components, reproducing a three-dimensional model on a screen by sequentially stacking parts to be stacked on the already stacked parts based on the shape data and the reference data, processing to delete or modify parts of the three-dimensional model on the screen, reproducing the three-dimensional model with its part deleted or modified, and if reproduction of the three-dimensional model is stopped at a certain part, searching for the cause of non-reproducibility, wherein:

the three-dimensional model immediately before the part is deleted or modified is stored;

the stored immediately preceding three-dimensional model is shown on the same screen together with the non-reproducible three-dimensional model whose reproduction was stopped at the certain part; and

a difference of the shape and reference data between both of the three-dimensional models is determined to extract shape and reference data which are missing from the non-reproducible part, and the extracted shape and reference data are converted into information indicating the cause of non-reproducibility and shown on the screen.

According to the first aspect of the invention, the three-dimensional model 50 which is non-reproducible is shown in window 43 and the three-dimensional model 30 immediately before deletion or modification of a part is shown in window 42 as shown in FIG. 10.

A difference between shape data and reference data on the part 13 which is non-reproducible among the components of the immediately preceding three-dimensional model 30 and shape data and reference data on the part 13 in data about the non-reproducible three-dimensional model 30 is determined. Then, shape data and reference data missing from the non-reproducible part 13 are extracted. The extracted shape data and reference data are shown as character information 45a indicating the cause of non-reproducibility in window 45.

According to the present invention, the reference data and shape data missing from the non-reproducible part are converted into information indicating the cause of non-reproducibility and shown on the screen, so that the operator can easily identify the cause of non-reproducibility Thus, the non-reproducible three-dimensional model can be restored quickly. And, efficiency of restoring the non-reproducible three-dimensional model can be improved.

A second aspect of the invention is directed to claim 1, wherein the non-reproducible part is shown at the pertinent position on the non-reproducible three-dimensional model on the screen.

A third aspect of the invention is directed to claim 1, wherein a modification plan to reproduce the three-dimensional model having the part deleted or modified is shown on the screen.

According to the second and third aspects of the invention, efficiency of restoring the non-reproducible three-dimensional model is improved furthermore.

### BRIEF DESCRIPTION OF THE DRAWINGS

FIG. 1 is a diagram showing a display screen perspectively showing a three-dimensional model of an embodiment;

FIG. 2 is a diagram showing the display screen perspectively showing the three-dimensional model of the embodiment;

FIG. 3 is a diagram showing the display screen perspectively showing a three-dimensional model of the embodiment;

FIG. 4 is a diagram showing the display screen perspectively showing the three-dimensional models of the embodiment;

FIG. 5 is a diagram showing the display screen perspectively showing the three-dimensional models of the embodiment;

FIG. 6 is a diagram showing the display screen perspectively showing the three-dimensional models of the embodiment;

FIG. 7 is a diagram showing the display screen perspectively showing the three-dimensional models of the embodiment;

FIG. 8 is a diagram showing the display screen perspectively showing the three-dimensional models of the embodiment;

FIG. 9 is a diagram showing the display screen perspectively showing the three-dimensional models of the embodiment;

FIG. 10 is a diagram showing the display screen perspectively showing the three-dimensional models of the embodiment;

FIG. 11 is a diagram showing the display screen perspectively showing the three-dimensional models of the embodiment;

FIG. 12 is a diagram showing the display screen perspectively showing a three-dimensional model of the embodiment;

FIG. 13 is a flow chart showing a procedure of processing of the embodiment;

FIG. 14 is a flow chart showing a procedure of processing of the embodiment;

FIG. 15 is a flow chart showing a procedure of processing of the embodiment;

FIG. 16 is a flow chart showing a procedure of processing of the embodiment; and

FIG. 17 is a sectional diagram of a three-dimensional model.

### DETAILED DESCRIPTION OF THE PREFERRED EMBODIMENTS

Embodiments of a three-dimensional CAD system will be described with reference to the accompanying drawings.

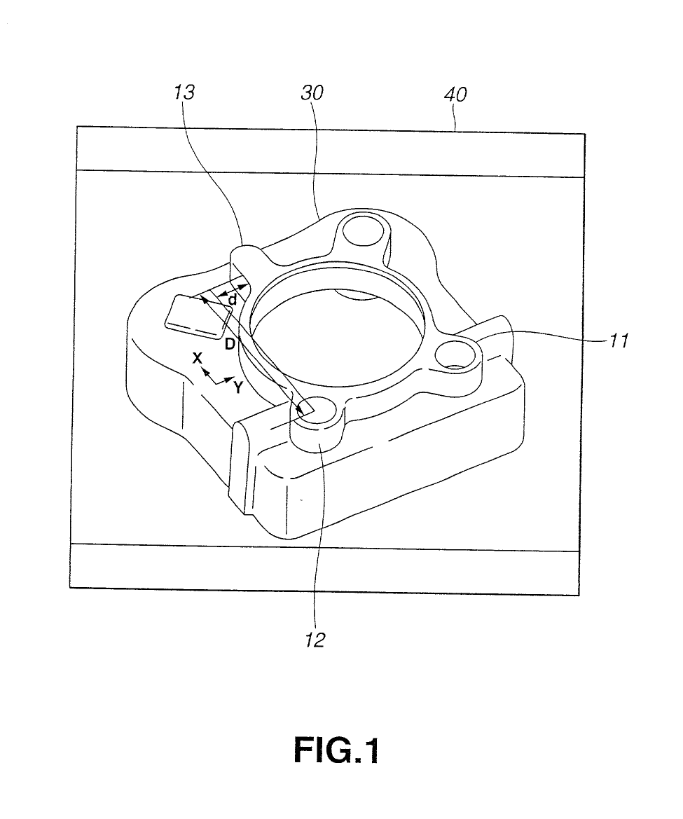

In this embodiment, it is assumed to configure the three-dimensional model 30 of a gear case by the three-dimensional CAD system as shown in FIG. 1. It is to be understood that the three-dimensional CAD system of this embodiment has the parametric function.

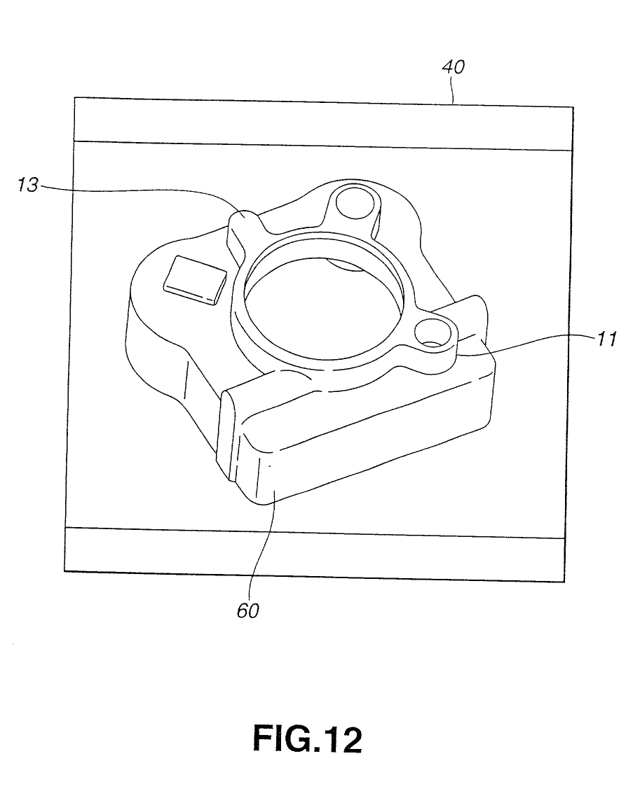

FIG. 1 to FIG. 12 show contents of the display screen 40 of a personal computer.

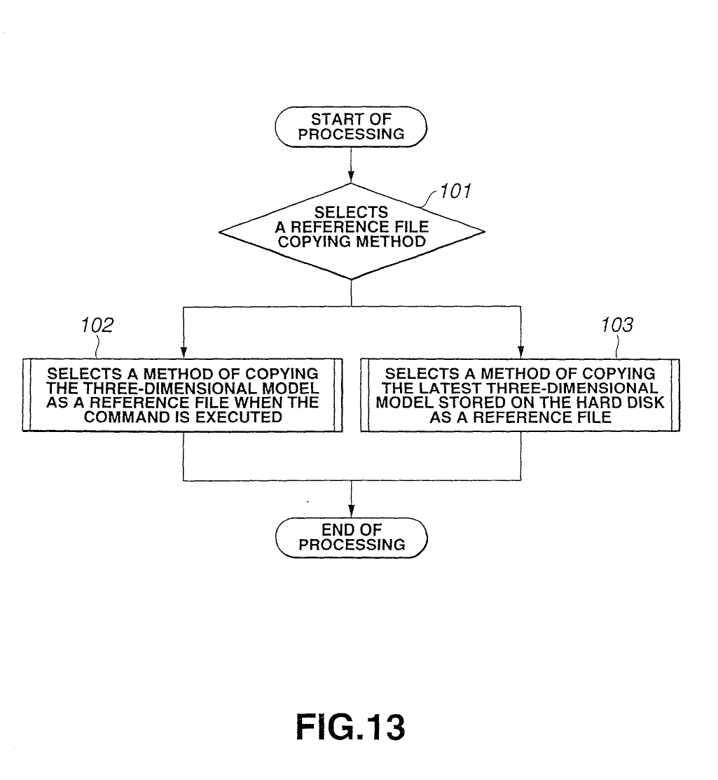

FIG. 13 to FIG. 16 show flow charts each roughly indicating a procedure of processing of the embodiment to show a flow of operation to complete the deletion or modification of a part of the three-dimensional model.

Detailed description will be made with reference to the aforementioned drawings.

FIG. 1 perspectively shows the three-dimensional model 30 of a gear case which is to be deleted or modified. The three-dimensional model 30 has respective components allotted identification ID Nos. 1 to 14 and is configured by stacking the parts while referencing to the existing stacked parts by other parts. According to the three-dimensional CAD system, the shape of the three-dimensional model 30 is reproduced by sequentially executing commands associated with the identification ID Nos. 1 to 14 in order of the identification ID Nos. 1, 2, 3 . . . 14. In the following description, reference numerals allotted to the respective components are the same as the identification IDs allotted to the respective components.

The projection 13 of the three-dimensional model 30 is determined its position with reference to at least one of parts having identification ID Nos. 1 to 12 and references to the boss 12 as one of them. The projection 13 has reference data (dimension information) describing “to form at a position distance D away in a positive direction of X axis from the center of the boss 12 and distance d away in a positive direction of Y axis”.

As shown in FIG. 13, an operator selects a method of copying a reference file before deleting or modifying the three-dimensional model. Here, the three-dimensional model may be the latest model stored or not stored on a hard disk. The operator selects a method of copying the reference file depending on each situation (step 101). The reference file is a file which stores data (e.g., shape data and reference data allotted to each component) about the immediately preceding three-dimensional model which is already reproduced successively when a command for deleting or modifying a part of the three-dimensional model is given. And, the copy means a process of storing the reference file on the hard disk in the three-dimensional CAD system.

In other words, the operator selects a method of copying data about the three-dimensional model as a reference file when the command for deleting or modifying the part is executed (step 102) or a method of copying, as a reference file, data about the latest three-dimensional model which is already stored on the hard disk when the part is deleted or modified (step 103).

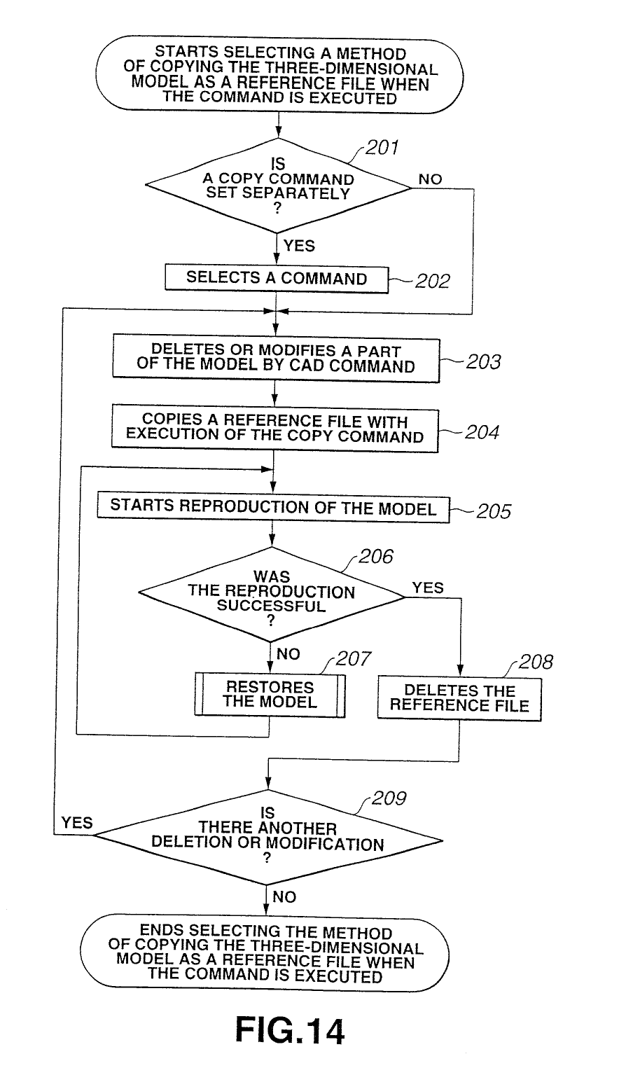

FIG. 14 is a flow chart showing a procedure when the method of copying as the reference file the data about the three-dimensional model when the selection processing of step 102 is performed and the command is executed is selected. This processing method must be selected when a new three-dimensional model is created because data on a three-dimensional model is not stored on the hard disk.

In the operation of deleting or modifying the three-dimensional model, various CAD commands are executed. It is selected by the operator whether the reference file is always copied every time each command is executed or the reference file is copied only when a particular command is executed among the respective commands (individual setting) (step 201). For example, the three-dimensional model does not become non-reproducible even if a command for modifying the dimensions of a part is executed. When such a command is executed, it is not necessary to copy the reference file and to perform processing to search for the cause of non-reproducibility to be described later. Conversely, when it is assumed that the command for deleting a part is executed, there is a possibility that the three-dimensional model may become non-reproducible. In such a case, necessity of copying the reference file is set for each command so that the reference file is not copied when the command for modifying the dimensions of the part is executed and the reference file is copied when the command for deleting the part is executed (decision YES in step 201) (step 202). Meanwhile, when the commands are not determined individually, the reference file is copied when all of commands are executed (decision NO in step 201).

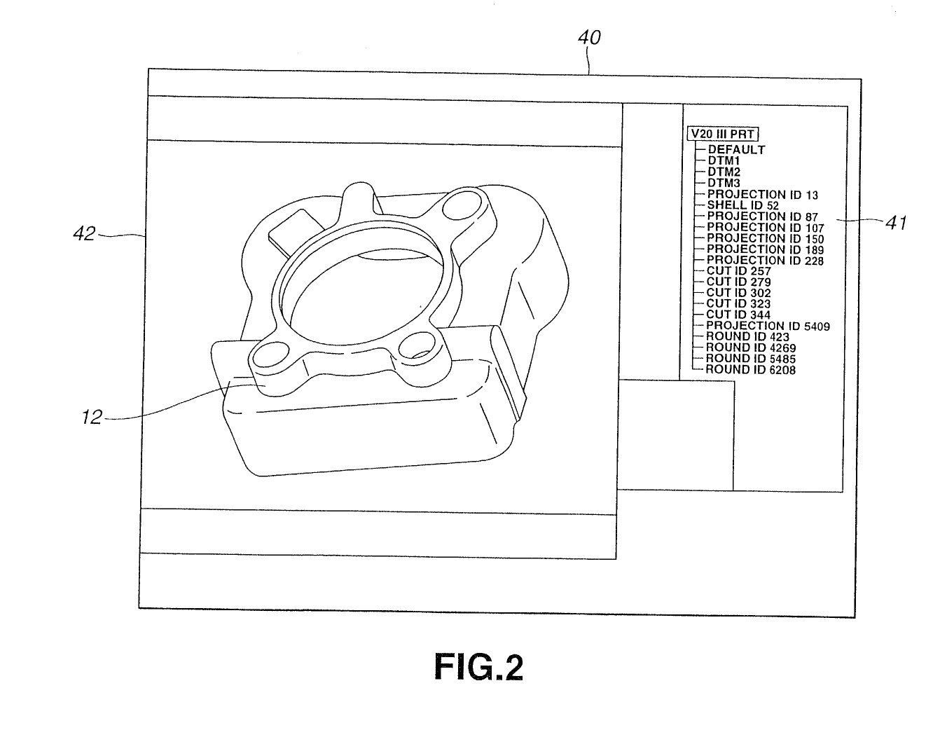

Then, the operator inputs the CAD command to the computer through input means such as a keyboard to delete or modify the part of the three-dimensional model. It is assumed in this embodiment that a command for deleting the boss 12 from the three-dimensional model 30 is input as shown in FIG. 2 (step 203). This deletion command can be selected from a command menu shown on the screen 40 of the display device of the computer. When the deletion command is input, data about the three-dimensional model 30 at the input of the deletion command or immediately before the execution of the deletion command is copied as a reference file on the hard disk (step 204).

Then, the reproduction of the three-dimensional model 30 from which the boss 12 is deleted is started by the execution of the deletion command (step 205). If the reproduction of the three-dimensional model 30 is successful (decision YES in step 206), the reference file which is copied on the hard disk is deleted (step 208), and it is judged whether another part, namely a part other than the boss 12, is deleted or modified (step 209). When another part is to be deleted or modified (decision YES in step 209), the CAD command is input again (step 203) to repeat the same process. When another part is not to be deleted or modified (decision NO in step 209), the process is terminated.

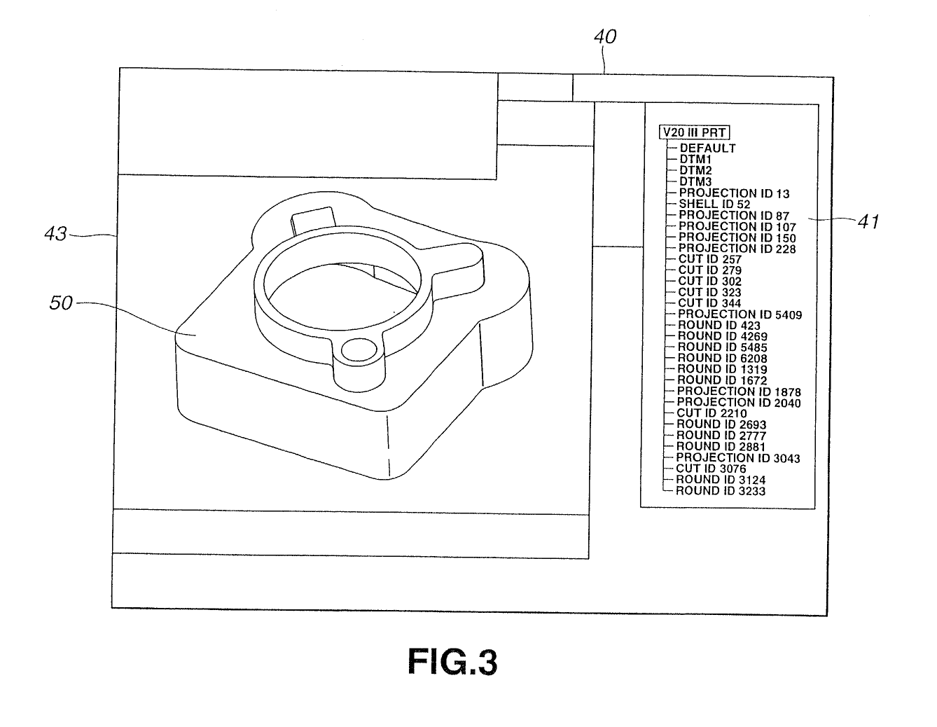

Meanwhile, if the reproduction of the three-dimensional model 30 fails, namely if the reproduction is stopped without completely reproducing all of its parts (decision NO in step 206), window 43 is opened on the screen 40 as shown in FIG. 3, and the three-dimensional model 50 (non-reproducible three-dimensional model 50) whose reproduction was stopped without completely reproducing all of its parts is displayed. A model tree of the non-reproducible three-dimensional model 50 is shown in the window screen 41 on the screen 40 of FIG. 3. Here, the model tree shows respective commands (“projection”, “round”, etc.) for reproducing the three-dimensional model as the shape of a tree.

In this embodiment, the projection 13 is associated with the boss 12 so to reference to it. When the boss 12 is deleted, the reference data about the projection 13 which directly references to the boss 12 is caused to have missing data. In other words, the reference data describing “to form at a position distance D away in a positive direction of X axis from the center of the boss 12 and distance d away in a positive direction of Y axis” possessed by the projection 13 is missing, and the projection 13 cannot be stacked on the three-dimensional model 30. When the projection 13 cannot be stacked, another part directly referencing to the projection 13 cannot be stacked additionally. Thus, the three-dimensional model 30 becomes non-reproducible, and stacking is stopped at a certain part, namely limited to parts which do not refer to the deleted boss 12.

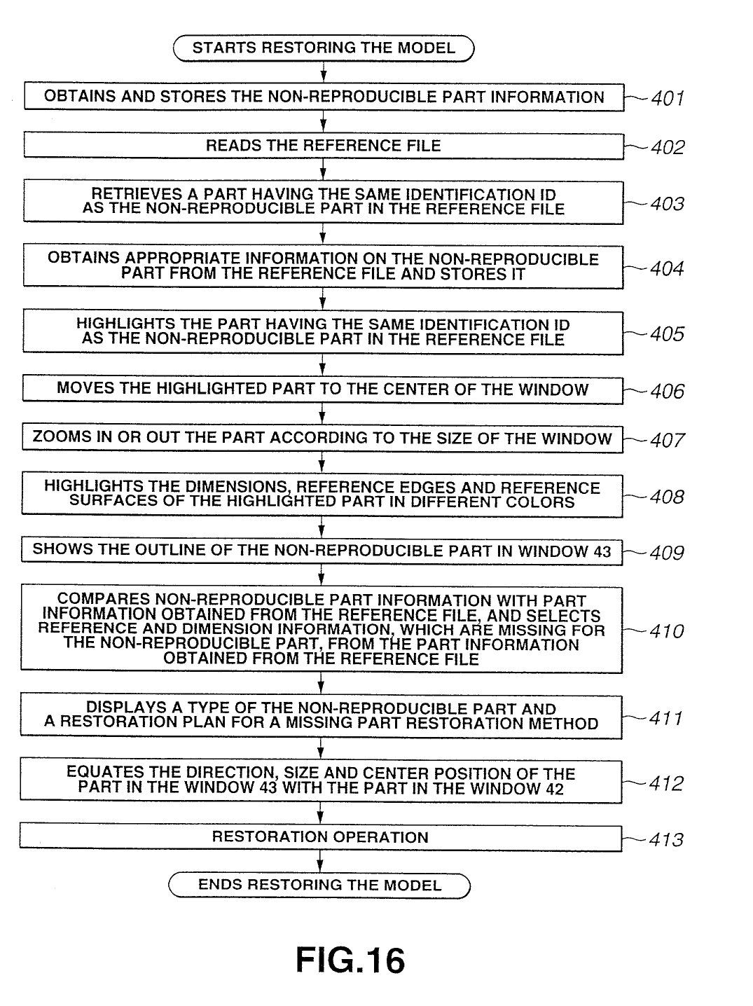

Then, the procedure shifts to the process shown in FIG. 16 to determine the cause of non-reproducibility and to restore the three-dimensional model 30 (step 207) as described later, and the restored three-dimensional model 30 is reproduced (step 205).

Specifically, the cause of non-reproducibility is identified (because the projection 13 is in the reference relation of being the distances D, d away from the deleted boss 12), the reference relation is restored (the reference relation is restored so that the projection 13 refers to another part other than the boss 12), and the three-dimensional model 30 is reproduced. Even if the reference relation of the projection 13 with another part is restored, when a part (e.g., a part with identification ID No. 14) to be additionally stacked on the projection 13 refers to the deleted boss 12, the part 14 becomes the cause of non-reproducibility, and the process of reproducing the three-dimensional model is interrupted, leaving the reproduction unfinished. In this case, it is necessary to identify the cause of non-reproducibility and to restore the reference relation in the same way.

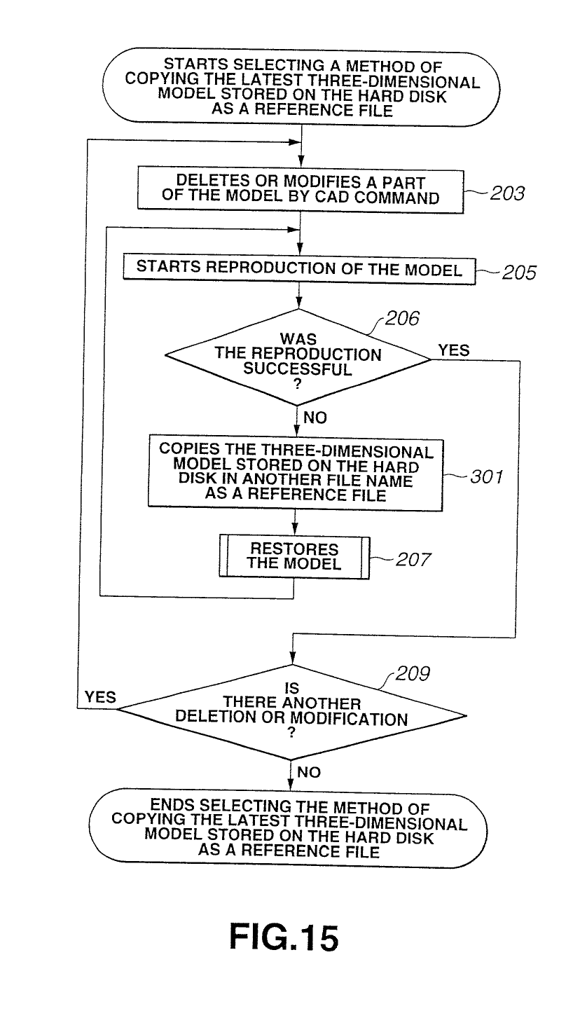

FIG. 15 is a flow chart showing a procedure when the selection process of the step 103 of FIG. 13 is performed and the method of copying data about the latest three-dimensional model as a reference file is selected. The same reference numerals are allotted to the same steps as those shown in FIG. 14 and the description is omitted.

When the selection process in the step 103 is executed as shown in FIG. 13, data about the three-dimensional model 30 has been stored on the hard disk. Therefore, a command for deleting or modifying a part of the three-dimensional model 30 is input (step 203), and the reproduction of the three-dimensional model 30 with the part deleted or modified is started (step 205). But, if it is not reproducible (decision NO in step 206), data about the latest three-dimensional model 30 stored on the hard disk is read, given another file name and copied as a reference file on the hard disk (step 301). Then, the cause of non-reproducibility is identified, and the three-dimensional model 30 is restored (step 207).

FIG. 16 is a flow chart showing the procedure of identifying the cause of non-reproducibility and restoring the three-dimensional model 30.

Since the boss 12 (identification ID No. 12) is deleted as described above, the three-dimensional model 30 cannot be stacked no more than a certain part, namely a part (identification ID No. 11) which does not refer to the deleted boss 12.

Therefore, the three-dimensional CAD system identifies, based on data about the non-reproducible three-dimensional model 50 whose reproduction is limited up to the part having identification ID No. 11 and the command for deleting the part having identification ID No. 12, that the non-reproducible part is a part (projection 13) having the next identification ID No. 13 and stores data about the identification ID No. 13 (step 401).

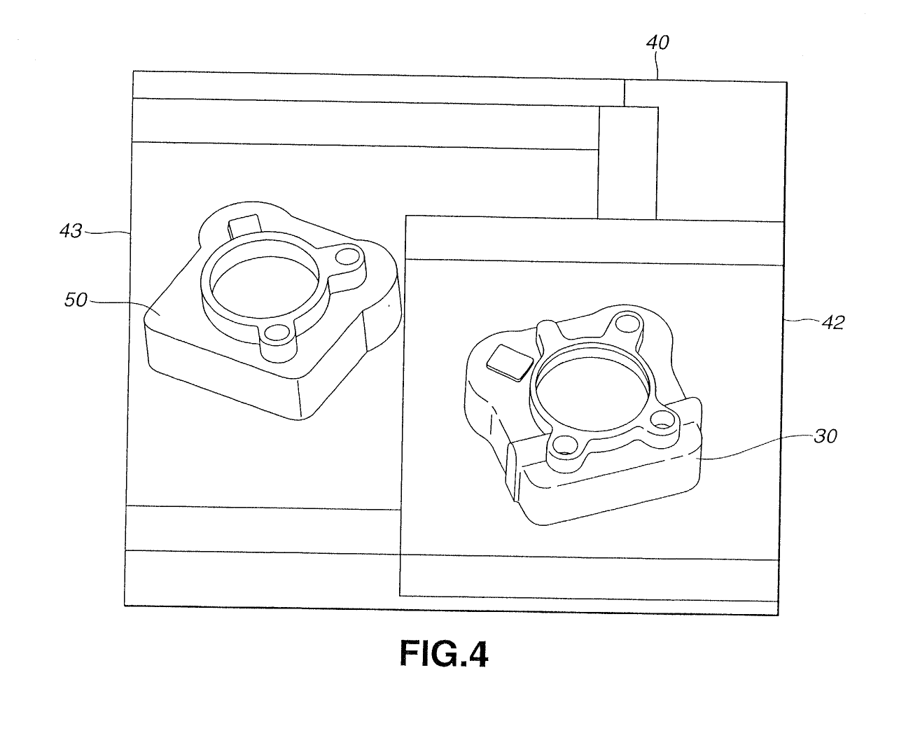

Then, the reference file copied on the hard disk is read. As a result, as shown in FIG. 4, window 42 is simultaneously opened to show the three-dimensional model 30 (immediately preceding three-dimensional model 32) immediately before the deletion of the boss 12 with the window 43 left open to show the non-reproducible three-dimensional model 50 on the screen 40. Thus, the non-reproducible three-dimensional model 50 and the immediately preceding three-dimensional model 30 are shown on the same screen 40.

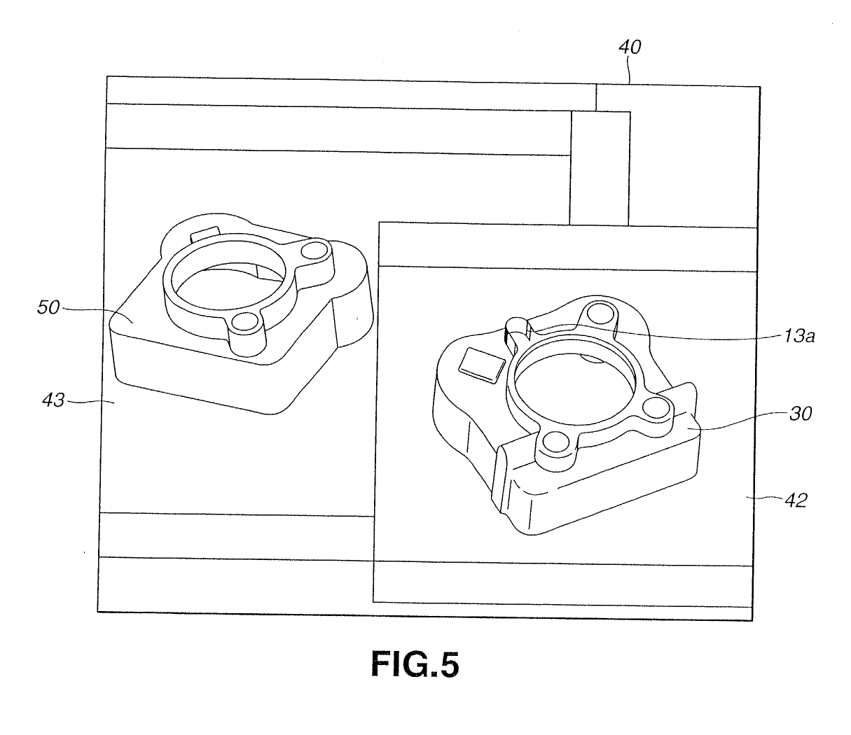

Then, the part (projection 13) to which the same identification ID as the identification ID No. 13 obtained in the step 401 is allotted is retrieved from the read reference file, namely from the immediately proceeding three-dimensional model 30 (step 403), and the reference data and shape data of the part (projection 13) are obtained and stored. The shape data includes wire frame 13a (see FIG. 5) showing the shape of the projection 13, the shape dimensions and the like, and the reference data includes portions such as edges and faces being referenced and dimensions from such portions (step 404).

Then, based on the obtained reference data and shape data, the wire frame 13a of the projection 13 is highlighted on the immediately preceding three-dimensional model 30 shown in the window 42 as shown in FIG. 5. For example, the wire frame 13a of the projection 13 is shown in a color distinguishable from other portions (step 405). Thus, the part (projection 13) which is non-reproducible in the non-reproducible three-dimensional model 50 can be checked on the immediately preceding three-dimensional model 30.

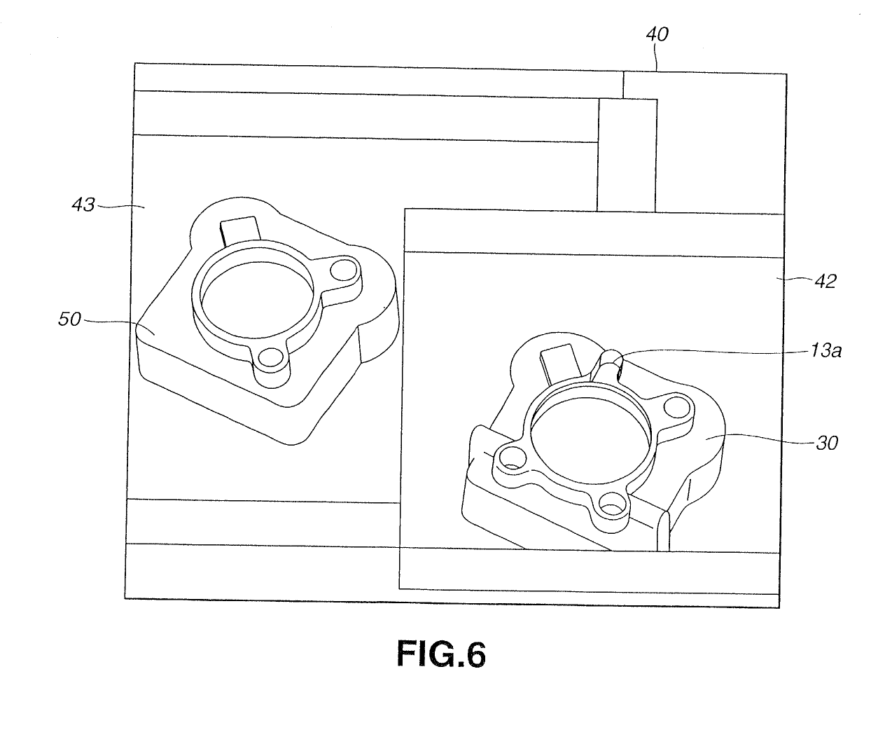

Then, to make it easy to see the non-reproducible projection 13, starting point return processing is performed to associate the coordinate starting point on the window 42 and the coordinate starting point on the CAD, and the projection 13 is moved to the center position of the window 42 as shown in FIG. 6. As a result, the immediately preceding three-dimensional model 30 shown in the window 42 has the same posture as the non-reproducible three-dimensional model 50 shown in the window 43 (step 406).

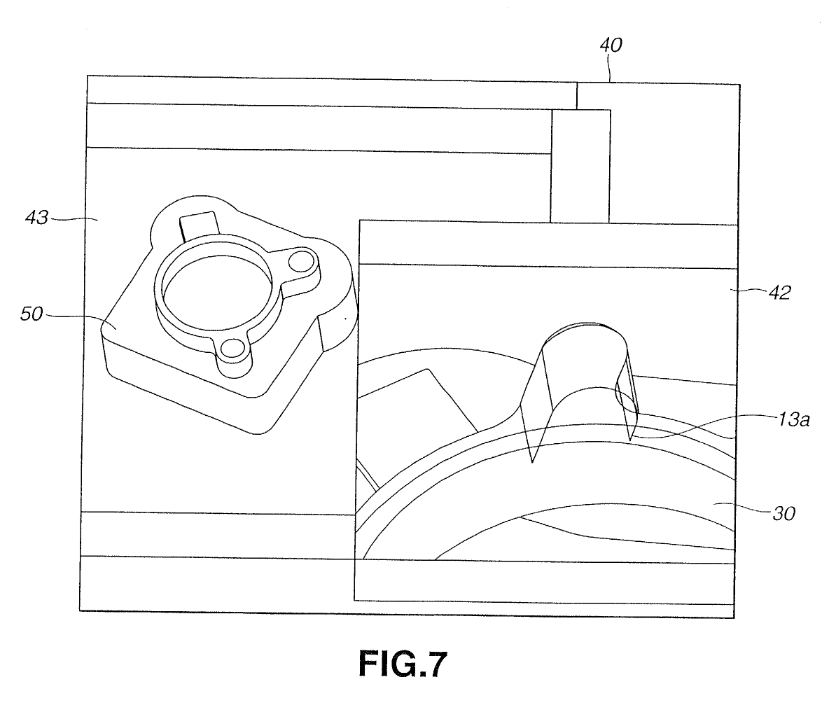

As shown in FIG. 7, the projection 13 is zoomed in (magnified) or zoomed out (reduced) on the window 42 so that its size is relatively changed with respect to the size of the window 42. FIG. 7 shows that the projection 13 is zoomed in to become large relative to the size of the window 42 (step 407). For the magnified display of the projection 13, the values of coordinates, window matrix and view matrix of the wire frame 13a are used. It may become easy to see the highlighted wire frame 13a by showing the part in a reduced size. In such a case, the part may be shown in a reduced size.

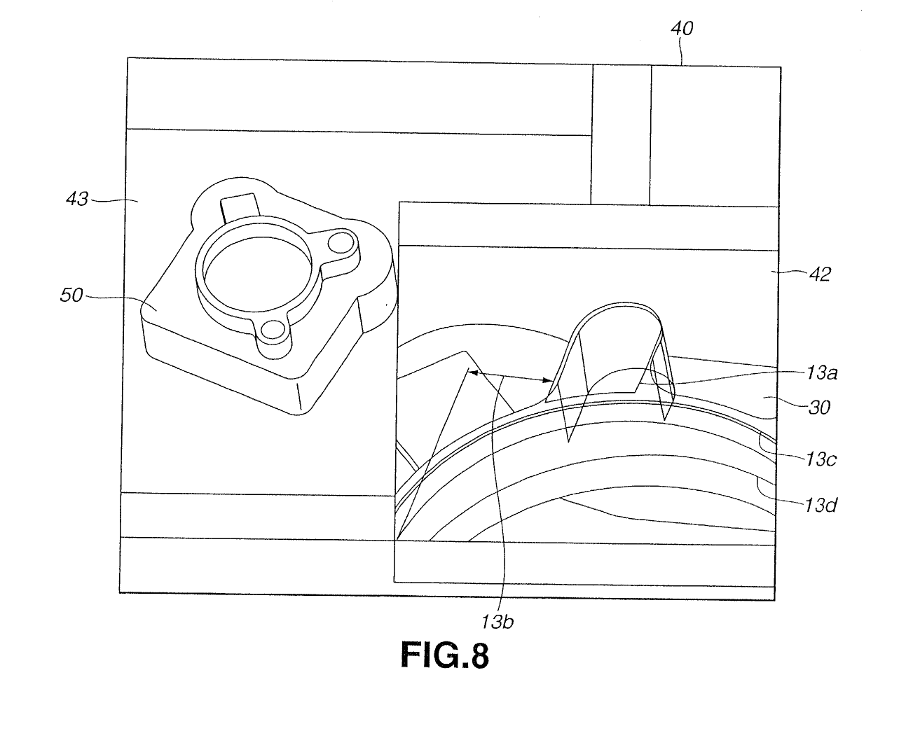

Then, as shown in FIG. 8, all of data, which can be shown on the window 42, among the reference data and shape data about the projection 13 obtained in the step 403 is displayed. For example, the wire frame 13a of the projection 13 is highlighted in red, the shape size 13b is highlighted in yellow, the referenced edge 13c is highlighted in blue, and the referenced surface 13d is highlighted in green (step 408).

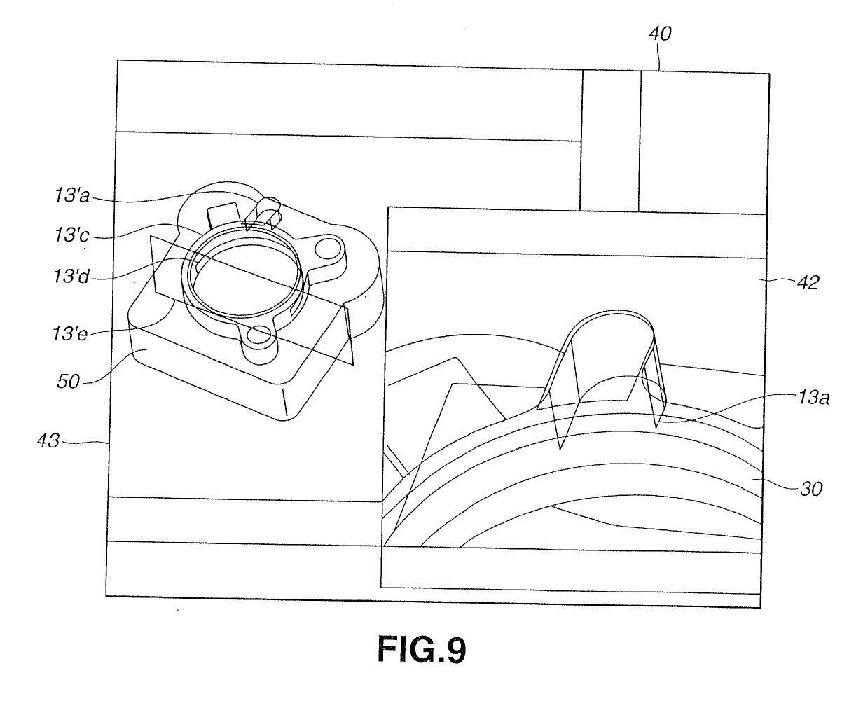

On the pertinent portion on the non-reproducible three-dimensional model 50 shown in the window 43, namely on the portion where the projection 13 must be present, wire frame 13′a which is the same as the wire frame 13a is shown in, for example, red so to be distinguishable from the other portions as shown in FIG. 9 (step 409).

Here, the immediately preceding three-dimensional model 30 has the projection 12 completely reproduced, so that data about the immediately preceding three-dimensional model 30 contains all of the reference data and shape data of the projection 13. Meanwhile, the non-reproducible three-dimensional model 50 can not reproduce the projection 13 which refers to the boss 12 because the boss 12 was deleted. Therefore, data (e.g., the “projection 13 is formed to have height h with respect to part 11”; it is hereinafter called the remaining data) which is not related to the boss 12 in the reference data and shape data about the projection 13 is still in the data about the non-reproducible three-dimensional model 50, but data (“the projection 13 is formed at a position distance D away in a positive direction of X axis from the center of the boss 12 and distance d away in a positive direction of Y axis”) about the boss 12 does not remain. In the reference and shape data about the projection 13, remained data 13′c, 13′d, 13′e which do not relate to the boss 12 are shown on the window 43 as shown in FIG. 9.

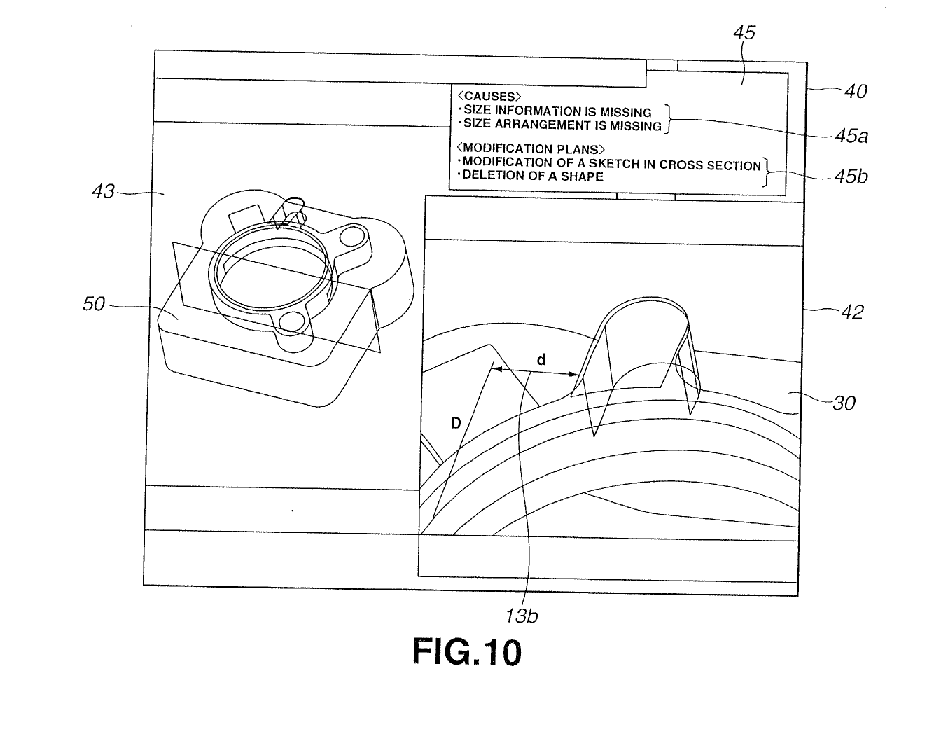

Accordingly, a difference between the shape and reference data about the non-reproducible part 13 in the data about the immediately preceding three-dimensional model 30 and afterimage data about the non-reproducible part 13 in the data on the non-reproducible three-dimensional model 50 is determined. Thus, only information (hereinafter called difference information) not remaining in the data about the non-reproducible three-dimensional model 50 is extracted. Specifically, because the boss 12 of the three-dimensional model 30 is deleted, only information (“the projection 13 is formed at a position distance D away in a positive direction of X axis from the center of the boss 12 and distance d away in a positive direction of Y axis”) indicating the reference relation with the lost boss 12 is extracted as difference information from the reference and shape data about the projection 13. As a result, shape size 13b (distances d, D from the boss 12) corresponding to the difference information is highlighted in color distinguishable from the other portions on the immediately preceding three-dimensional model 30 shown in the window 42 as shown in FIG. 10 (step 410).

Besides, the aforementioned difference information is converted into character information 45a such as “size information is missing” or “size arrangement is missing” and shown on another window screen 45. According to the character information 45a, the operator can check which data (size information, size arrangement) is missing so to know why the part (projection 13) with identification ID No. 13 is non-reproducible. Thus, the cause of non-reproducibility can be checked.

Based on the difference information, a plurality of command operations to restore the three-dimensional model 50, namely restoration ideas, are extracted, and character information 45b such as “modification of a sketch in cross section” or “deletion of a shape” is shown on the window screen 45 (step 411).

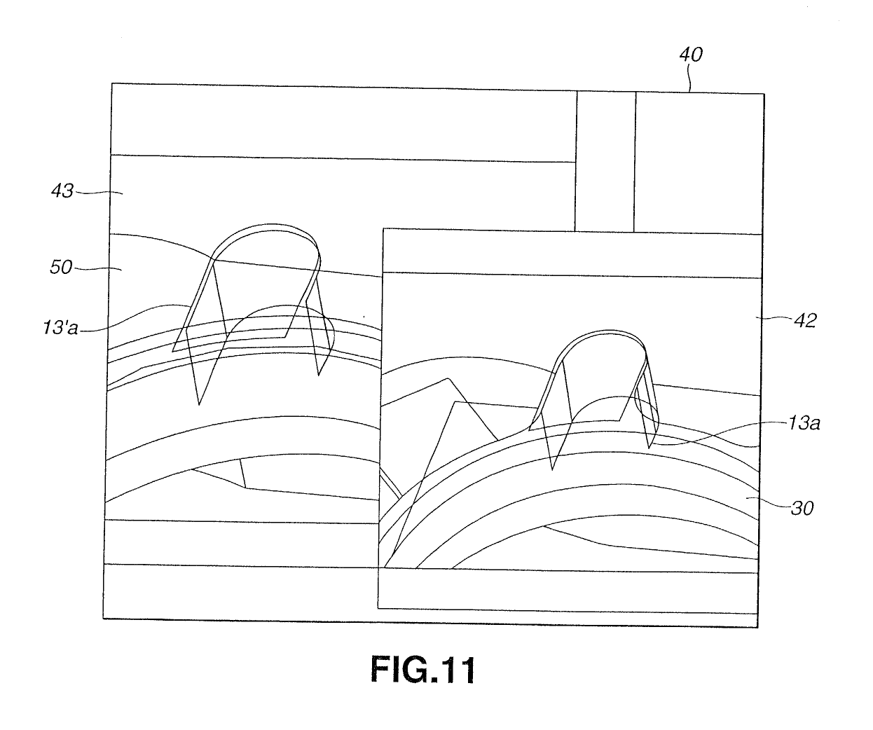

Then, the non-reproducible three-dimensional model 50 is zoomed in on the window 43 so that the wire frame 13′a on the non-reproducible three-dimensional model 50 shown in the window 43 is made to have the same direction and size as the wire frame 13 on the immediately preceding three-dimensional model 30 shown in the window 42 as shown in FIG. 11 (step 412). The enlarged display of the wire frame 13′a can be made by reproducing the coordinate position, direction, window matrix information and view matrix information of the wire frame 13a in the window 42 on the window 43.

The operator restores the three-dimensional model 30 depending on the cause of non-reproducibility and correction plan described above. To restore the three-dimensional model 30, an appropriate operation command is selected from all the operation menu of the three-dimensional CAD system in the same way as the deletion or correction operation for the ordinary parts. But, the correction plan of the three-dimensional model 30 is shown as the character information 45b on the window 45 as an operation command in this embodiment, so that this character information 45b may be clicked to move to a directly associated operation command (step 413).

As a result, the reference data about the projection 13 is modified to, for example, “distance E away in direction X and distance e in direction Y from the boss 11, another part other than the boss 12” to restore the three-dimensional model 30 as shown in FIG. 1. And, the restored three-dimensional model 30 is started to be reproduced (step 205 in FIG. 14 and FIG. 15), and its reproduction is successful as the three-dimensional model 30 is stacked up to final part 15 (decision YES in step 206 of FIG. 14 and FIG. 15). In other words, when the projection 13 is reproduced and if reference data and shape data of other parts do not have any missing data, the three-dimensional model 60 of a gear case is shown on the screen 40 as shown in FIG. 11.

Even if the three-dimensional model 30 is restored so that the projection 13 references to the boss 11, when the part 14 with identification ID No. 14 which is further stacked on the projection 13 refers to the deleted boss 12, the part 14 then becomes the cause of non-reproducibility, and the reproduction of the three-dimensional model is interrupted (decision NO in step 206 of FIG. 14 and FIG. 15). In this case, the process shown in FIG. 16 is performed in the same way to identify the cause of non-reproducibility in the same way, and the three-dimensional model 30 is restored again.

According to this embodiment, the immediately preceding three-dimensional model 30 and the non-reproducible three-dimensional model 50 are shown on the screen 40, a difference between the shape data and reference data of the part 13 which is non-reproducible among the components of the immediately preceding three-dimensional model 30 and the shape data and reference data of the part 13 in data on the non-reproducible three-dimensional model 50 is determined, the shape data and reference data missing from the non-reproducible part 13 are extracted, and the extracted shape data and reference data are shown as the character information 45a indicating the cause of non-reproducibility on the window 45, so that the operator can easily identify the cause of non-reproducibility. Therefore, the non-reproducible three-dimensional model 30 is restored promptly. Thus, the restoration operation of the non-reproducible three-dimensional model 30 is improved its efficiency.

It is assumed in the aforementioned embodiment that a part is deleted from the three-dimensional model 30, but the present invention can also be applied to correction of parts configuring the three-dimensional model 30.

With reference to FIG. 17, an example that when a part configuring three-dimensional model 70 is modified, the modified three-dimensional model 70 becomes non-reproducible will be described.

FIG. 17 shows a sectional diagram of the three-dimensional model 70. It is assumed that the three-dimensional model 70 is configured of parts 71, 72, 73. It is also assumed that the part 73 is reproduced by referencing to edge 72a of the part 72. In other words, the part 73 is allotted reference data “being distance d away from the edge 72a of the part 72”. Then, it is assumed that the part 72 is modified, and the edge 72a is deleted to change to radius 72b (indicated by a broken line). This modification makes to delete reference data “being distance d away from the edge 72a of the part 72” among the shape and reference data on the part 73. Thus, because the part 72 is modified, even if the part 73 referencing to the part 72 becomes non-reproducible, the same process as in the aforementioned embodiment can be performed to identify the cause of non-reproducibility so to restore the three-dimensional model 70.

What is claimed is:

1. A three-dimensional CAD system which comprises allotting shape data indicating the shape of a part to each component, allotting reference data indicating a reference relation to between components, reproducing a three-dimensional model on a screen by sequentially stacking parts to be stacked on the already stacked parts based on the shape data and the reference data, processing to delete or modify parts of the three-dimensional model on the screen, reproducing the three-dimensional model with its part deleted or modified, and if reproduction of the three-dimensional model is stopped at a certain part, searching for the cause of non-reproducibility, wherein:
the three-dimensional model immediately before the part is deleted or modified is stored;
the stored immediately preceding three-dimensional model is shown on the same screen together with the non-reproducible three-dimensional model whose reproduction was stopped at the certain part; and
a difference of the shape and reference data between both of the three-dimensional models is determined to extract shape and reference data which are missing from the non-reproducible part, and the extracted shape and reference data are converted into information indicating the cause of non-reproducibility and shown on the screen.

2. The three-dimensional CAD system according to claim 1, wherein the non-reproducible part is shown at the pertinent position on the non-reproducible three-dimensional model on the screen.

3. The three-dimensional CAD system according to claim 1, wherein a modification plan to reproduce the three-dimensional model having the part deleted or modified is shown on the screen.
